(19) United States
(12) Patent Application Publication
(10) Pub. No.: US 2015/0259517 A1
(43) Pub. Date: Sep. 17, 2015

(54) HIGH-STYRENE CONTENT SBR IN RUBBER COMPOSITIONS

(71) Applicant: Xiaofeng, Shaw YANG, Greenville, SC (US)

(72) Inventor: Xiaofeng Shaw Yang, Simpsonville, SC (US)

(73) Assignees: COMPAGNIE GENERALE DES ESTABLISSMENTS MICHHEIN; Michelin Recherche et Technique S.A. a corporation

(21) Appl. No.: 14/437,452

(22) PCT Filed: Oct. 24, 2012
(86) PCT No.: PCT/US2012/061745

§ 371 Date: Apr. 21, 2015

(51) Int. Cl. C08L 9/06; C08L 7/00

(52) U.S. Cl. CPC C08L 9/06; C08L 7/00

(57) ABSTRACT

Tire components made of rubber compositions that comprises, per 100 parts by weight of rubber (phr) 100 phr or an essentially unsaturated diene rubber, between 30 phr and 150 phr of a reinforcing filler and between 2 phr and 50 phr of a high-styrene content styrene-butadiene copolymer additive, the styrene-butadiene copolymer additive having a styrene content of between 50 wt. % and 90 wt. %. Alternatively, the styrene content of the styrene-butadiene copolymer additive may be between 55 wt. % and 80 wt. %. Because the rigidity of the resulting cured rubber composition is high, particular embodiments may include components around the bead area of a tire and tire treads, including winter tire treads.

### BACKGROUND OF THE INVENTION

1. Field of the Invention

This invention relates generally to rubber compositions and more particularly, to rubber compositions having a styrene-butadiene copolymer having high styrene content, articles made from such rubber compositions and methods for making same.

2. Description of the Related Art

Some articles that are made at least in part of rubber compositions have the need to be formed of a rubber composition characterized as having a high rigidity and/or hardness. There are different techniques known to those skilled in the art to increase the rigidity of a rubber composition by using, for example, higher loading of the reinforcing filler, use of reinforcing resins and/or higher loadings of vulcanization agents that result in more cross-linking in the rubber composition and thus an increase in the rigidity property of the cured rubber composition.

It is known to these same skilled artisans that tire designers must often compromise on certain characteristics of the tires they are designing. Changing the tire design to improve one characteristic will often result in a compromise; i.e., an offsetting decline in another tire characteristic. One such compromise exists when using higher loadings of reinforcing fillers or vulcanization agents or when using a reinforcing resin to increase the rigidity of the cured rubber composition, the compromise being between the desired increased rigidity obtained and the degradation in other properties of the cured and uncured rubber composition. Indeed, as a result of such higher loadings, there results an increase in the viscosity and a decrease in the scorch of the uncured rubber composition and degraded elongation and tear properties of the cured rubber composition.

The rubber industry, including the tire industry, continues to search for new materials and tire structures that can break some of the known compromises. Additives or other materials that may be included in a rubber composition to increase the rubber's desirable properties in one area without adversely affecting the properties as expected in another area are materials that break a known compromise.

### SUMMARY OF THE INVENTION

Particular embodiments of the present invention include tire components that are made of rubber compositions based upon a cross-linkable elastomer composition that comprises, per 100 parts by weight of rubber (phr), 100 phr of an essentially unsaturated diene rubber, between 30 phr and 150 phr of a reinforcing filler and between 2 phr and 50 phr of a high-styrene content styrene-butadiene copolymer additive, the styrene-butadiene copolymer additive having a styrene content of between 50 wt. % and 90 wt. %. The rubber composition may further include a vulcanization system for curing the elastomer composition.

In some embodiments, the styrene content of the styrene-butadiene copolymer additive may be between 55 wt. % and 80 wt. %. Because the rigidity of the resulting cured rubber composition may be characterized as being of a high rigidity, tire components of particular embodiments of the present invention may include components around the bead area of a tire and tire treads, including winter tire treads.

The foregoing and other objects, features and advantages of the invention will be apparent from the following more detailed descriptions of particular embodiments of the invention.

### DETAILED DESCRIPTION OF PARTICULAR EMBODIMENTS

Particular embodiments of the present invention include rubber compositions that contain a high-styrene content styrene-butadiene copolymer, the rubber composition being useful for making rubber articles and being particularly useful for making rubber articles that have a high rigidity. The styrene-butadiene copolymer added to such rubber compositions is characterized as having a high styrene content; i.e., a styrene content of at least 50 wt. %.

Surprisingly it has been discovered that by adding the high-styrene content styrene-butadiene copolymer to a rubber composition, the cured rigidity of the rubber composition is increased without a corresponding decrease in the cohesive properties of the cured rubber composition as typically occurs when the rigidity is increased by using an increased amount of reinforcing filler or vulcanization agent or by adding a reinforcing resin. Furthermore the uncured properties of the rubber composition are improved as the Mooney viscosity decreases and the scorch time increases, again breaking that compromise.

As used herein, “diene elastomer” and “rubber” are synonymous terms and may be used interchangeably.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

Reference will now be made in detail to embodiments of the invention, provided by way of an explanation and by examples of embodiments of the invention. For example, features illustrated or described as part of one embodiment can be used with another embodiment to yield still a third embodiment. It is intended that the present invention include these and other modifications and variations.

The rubber compositions disclosed herein are useful for many types of articles that are made of rubber, including tire components, hoses, conveyor belts and so forth. Since these rubber compositions, upon curing, may be characterized as having high rigidity, they are particularly useful for the manufacture of tire components where high rigidity properties are often desired such as in the bead area, e.g., the apex, bead filler and chafer. The beads, as known in the art, are the wire hoops that anchor the tire cords that extend from bead to bead. The rubber compositions are also useful as a material for the tire tread, including retread rubber useful for retreading a tire. They are also useful for treads that require high rigidity but normally do not experience high temperature operation such as, for example, winter or snow tires and agriculture tires.

The high-styrene content styrene-butadiene copolymer additive included in the rubber compositions disclosed here is a copolymer of styrene and butadiene. SBR rubber, also a copolymer of styrene and butadiene, is one of the most commonly used rubbers in the industry. Such copolymers are typically manufactured by one of two processes—an emulsion process producing E-SBR and a solution process producing S-SBR. Either process is acceptable for the high-styrene content styrene-butadiene copolymer useful as an additive to the rubber compositions disclosed herein as long as the styrene content is within the disclosed range.

It should be noted that the SBR rubber typically used in tire manufacturing is around 25 wt. % styrene or as high as 45 wt. %. As the styrene content increases over that level, the “rubbery” nature of the rubber begins to decline and the elastomer becomes more rigid. Thus these SBR's with higher levels of styrene have not typically been used in tire manufacturing.

In the rubber compositions disclosed herein, the high-styrene content styrene-butadiene copolymer additive has a styrene content of at least 50 wt. % or alternatively of between 50 wt. % and 90 wt. %. In particular embodiments, the styrene content may be between 55 wt. % and 80 wt. %, between 60 wt. % and 80 wt. % or between 60 wt. % and 75 wt. %. The amount of the styrene-butadiene copolymer added to the rubber compositions may be between 2 phr and 50 phr or alternatively between 5 phr and 50 phr, between 10 phr and 40 phr, between 5 phr and 40 phr, between 5 phr and 30 phr or between 10 phr and 30 phr.

It should be noted that the high-styrene content styrene-butadiene copolymer additive is included in the rubber compositions disclosed herein not as part of the rubber component of the rubber composition but as a separate additive. As such, the rubber component includes all the elastomer material added to the composition but the high-styrene content styrene-butadiene copolymer additive, as discussed herein, is not included as a part of the rubber component. In other words, all of the rubber compositions disclosed herein have 100 phr of rubber but the high-styrene content styrene-butadiene copolymer additive is not included in this 100 phr content. Of course those skilled in the art understand that the high-styrene content styrene-butadiene copolymer may be included in the “elastomer” portion of the rubber composition by multiplying a factor to the composition but such inclusion is merely a different method of accounting for the components in the rubber composition.

The useful elastomers of the rubber composition disclosed herein include highly unsaturated diene elastomers. Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol.%.

Thus, for example, diene elastomers such as butyl rubbers, nitrile rubbers or copolymers of dienes and of alpha-olefins of the ethylene-propylene diene terpolymer (EPDM) type or the ethylene-vinyl acetate copolymer type, do not fall within the preceding definition and may in particular be described as “essentially saturated” diene elastomers (low or very low content of units of diene origin, i.e., less than 15 mol. %). Particular embodiments of the present invention include no essentially saturated diene elastomers.

Within the category of essentially unsaturated diene elastomers are the highly unsaturated diene elastomers, which are understood to mean in particular diene elastomers having a content of units of diene origin (conjugated dienes) that is greater than 50 mol.%. Particular embodiments of the present invention may include not only no essentially saturated diene elastomers but also no essentially unsaturated diene elastomers that are not highly unsaturated.

The rubber elastomers suitable for use with particular embodiments of the present invention include highly unsaturated diene elastomers, for example, polybutadienes (BR), polyisoprenes (IR), natural rubber (NR), butadiene copolymers, isoprene copolymers and mixtures of these elastomers. The polyisoprenes include synthetic cis-1,4 polyisoprene, which may be characterized as possessing cis-1,4 bonds at more than 90 mol.% or alternatively, at more than 98 mol.%.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof. To be clear, the styrene content of these copolymers is less than 50 wt. % styrene or alternatively, less than 40 wt. %, less than 30 wt. % or between 20 wt. % and 45 wt. %.

It should be noted that any of the highly unsaturated elastomers may be utilized in particular embodiments as a functionalized elastomer. Elastomers can be functionalized by reacting them with suitable functionalizing agents prior to or in lieu of terminating the elastomer. Exemplary functionalizing agents include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates, imines, and epoxides. These types of functionalized elastomers are known to those of ordinary skill in the art. While particular embodiments may include one or more of these functionalized elastomers solely as the rubber component, other embodiments may include one or more of these functionalized elastomers mixed with one or more of the non-functionalized highly unsaturated elastomers.

In addition to the rubber component and the high-styrene content styrene-butadiene copolymer additive, a reinforcing filler is included in the rubber compositions disclosed herein. Reinforcing fillers are well known in the art and include, for example, carbon blacks and silica. Any reinforcing filler known to those skilled in the art may be used in the rubber composition either by themselves or in combination with other reinforcing fillers. In particular embodiments of the rubber composition disclosed herein, the filler is essentially a carbon black.

Carbon black, which is an organic filler, is well known to those having ordinary skill in the rubber compounding field. The carbon black included in the rubber compositions produced by the methods disclosed herein may, in particular embodiments for example, be in an amount of between 30 phr and 150 phr or alternatively 40 phr and 150 phr between 50 phr and 100 phr, between 20 phr and 60 phr. Advantageously, by adding the high-styrene content styrene-butadiene copolymer additive as disclosed herein, the amount of carbon black may be reduced and still obtain a desired rigidity of the cured rubber composition, thereby further increasing the beneficial effects of the additive by reducing the detrimental effects of the carbon black compromise, i.e., poorer cohesive properties after cure and in general poorer processability in the green state.

Suitable carbon blacks are any carbon blacks known in the art and suitable for the given purpose. Suitable carbon blacks of the type HAF, ISAF and SAF, for example, are conventionally used in tire treads. Non-limitative examples of carbon blacks include, for example, the N115, N134, N234, N299, N326, N330, N339, N343, N347, N375 and the 600 series of carbon blacks, including, but not limited to N630, N650 and N660 carbon blacks.

As noted above, silica may also be useful as reinforcement filler. The silica may be any reinforcing silica known to one having ordinary skill in the art including, for example, any precipitated or pyrogenic silica having a BET surface area and a specific CTAB surface area both of which are less than 450 m²/g or alternatively, between 30 and 400 m²/g may be suitable for particular embodiments based on the desired properties of the cured rubber composition. Particular embodiments of rubber compositions disclosed herein may include a silica having a CTAB of between 80 and 200 m²/g, between 100 and 190 m²/g, between 120 and 190 m²/g or between 140 and 180 m²/g. The CTAB specific surface area is the external surface area determined in accordance with Standard AFNOR-NFT-45007 of November 1987.

Highly dispersible precipitated silicas (referred to as “HDS”) may be useful in particular embodiments of such rubber compositions disclosed herein, wherein “highly dispersible silica” is understood to mean any silica having a substantial ability to disagglomerate and to disperse in an elastomeric matrix. Such determinations may be observed in known manner by electron or optical microscopy on thin sections. Examples of known highly dispersible silicas include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber.

When silica is added to the rubber composition, a proportional amount of a silane coupling agent is also added to the rubber composition. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Any of the organosilicon compounds that contain sulfur and are known to one having ordinary skill in the art are useful for practicing embodiments of the present invention. Examples of suitable silane coupling agents having two atoms of silicon in the silane molecule include 3,3′-bis(triethoxysilylpropyl) disulfide and 3,3′-bis(triethoxy-silylpropyl) tetrasulfide (known as Si69). Both of these are available commercially from Degussa as X75-S and X50-S respectively, though not in pure form. Degussa reports the molecular weight of the X50-S to be 532 g/mole and the X75-S to be 486 g/mole. Both of these commercially available products include the active component mixed 50-50 by weight with a N330 carbon black. Other examples of suitable silane coupling agents having two atoms of silicon in the silane molecule include 2,2′-bis(triethoxysilylethyl) tetrasulfide, 3,3′-bis(tri-t-butoxy-silylpropyl) disulfide and 3,3′-bis(di t-butylmethoxysilylpropyl) tetrasulfide. Examples of silane coupling agents having just one silicon atom in the silane molecule include, for example, 3,3′(triethoxysilylpropyl) disulfide and 3,3′ (triethoxy-silylpropyl) tetrasulfide. The amount of silane coupling agent can vary over a suitable range as known to one having ordinary skill in the art. Typically the amount added is between 7 wt. % and 15 wt. % or alternatively between 8 wt. % and 12 wt. % or between 9 wt. % and 11 wt. % of the total weight of silica added to the rubber composition.

Particular embodiments of the rubber compositions disclosed herein may include no processing oil or very little, such no more than 5 phr. Processing oils are well known to one having ordinary skill in the art, are generally extracted from petroleum and are classified as being paraffinic, aromatic or naphthenic type processing oil, including MES and TDAE oils. Processing oils are also known to include, inter alia, plant-based oils, such as sunflower oil, rapeseed oil and vegetable oil. Some of the rubber compositions disclosed herein may include an elastomer, such as a styrene-butadiene rubber, that has been extended with one or more such processing oils but such oil is limited in the rubber composition of particular embodiments as being no more than 10 phr of the total elastomer content of the rubber composition.

The rubber compositions disclosed herein may further include, in addition to the compounds already described, all or part of the components often used in diene rubber compositions intended for the manufacture of tires, such as plasticizers, pigments, protective agents of the type that include antioxidants and/or antiozonants, vulcanization retarders, a vulcanization system based, for example, on sulfur or on a peroxide, vulcanization accelerators, vulcanization activators, extender oils and so forth. There may also be added, if desired, one or more conventional non-reinforcing fillers such as clays, bentonite, talc, chalk or kaolin.

The vulcanization system is preferably, for particular embodiments, one based on sulfur and on an accelerator but other vulcanization agents known to one skilled in the art may be useful as well. Use may be made of any compound capable of acting as an accelerator of the vulcanization of elastomers in the presence of sulfur, in particular those chosen from the group consisting of 2-mercaptobenzothiazyl disulfide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazolesulphenamide (abbreviated to “TBBS”), N-tert-butyl-2-benzothiazole-sulphenimide (abbreviated to “TBSI”) and the mixtures of these compounds. Preferably, a primary accelerator of the sulfenamide type is used.

The vulcanization system may further include various known secondary accelerators or vulcanization activators, such as zinc oxide, stearic acid and guanidine derivatives (in particular diphenylguanidine).

The rubber compositions that are embodiments of the present invention may be produced in suitable mixers in a manner known to those having ordinary skill in the art. Typically the mixing may occur using two successive preparation phases, a first phase of thermo-mechanical working at high temperature followed by a second phase of mechanical working at a lower temperature.

The first phase, sometimes referred to as a “non-productive” phase, includes thoroughly mixing, for example by kneading in a Banbury type mixer, the various ingredients of the composition but excluding the vulcanization agents. It is carried out in a suitable kneading device, such as an internal mixer, until under the action of the mechanical working and the high shearing imposed on the mixture, a maximum temperature of generally between 120° C. and 190° C. is reached.

After cooling the mixture a second phase of mechanical working is implemented at a lower temperature. Sometimes referred to a “productive” phase, this finishing phase consists of incorporating the vulcanization agents into the rubber composition using a suitable device, such as an open mill. It is performed for an appropriate time (typically, for example, between 1 and 30 minutes or between 2 and 10 minutes), and at a sufficiently low temperature, i.e., lower than the vulcanization temperature of the mixture, so as to protect against premature vulcanization.

The rubber composition can be formed into useful articles, including tire components. Tire treads, for example, may be formed as tread bands and then later made a part of a tire, either procured or not, or they be formed directly onto a tire carcass by, for example, extrusion and then cured in a mold. Other components such as those located in the bead area of the tire or in the sidewall may be formed and assembled into a green tire and then cured with the curing of the tire.

The invention is further illustrated by the following examples, which are to be regarded only as illustrations and not delimitative of the invention in any way. The properties of the compositions disclosed in the examples were evaluated as described below.

Mooney Plasticity (ML 1+4) was measured in accordance with ASTM Standard D1646. In general, the composition in an uncured state is molded in a cylindrical enclosure and heated to 100° C. After 1 minute of preheating, the rotor turns within the test sample at 2 rpm, and the torque used for maintaining this movement is measured after 4 minutes of rotation. The Mooney Plasticity is expressed in “Mooney units” (MU, with 1 MU=0.83 Newton-meter).

Scorch was measured in accordance with ASTM Standard D1646 at 130° C. In general, Mooney scorch is reported as the time required for the viscosity to rise a set number of Mooney units above the minimum viscosity at the measured temperature.

Moduli of elongation (MPa) were measured at 10% (MA10) and at 100% (MA100) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

The elongation property was measured as elongation at break (%) and the corresponding elongation stress (MPa), which is measured at 23° C. in accordance with ASTM Standard D412 on ASTM C test pieces.

Tear properties were determined from test samples cut from a cured plaque with a thickness of approximately 2.5 mm. Notches (perpendicular to the test direction) were created in the samples prior to testing. The force and elongation at break was measured using an Instron 5565 Uniaxial Testing System. The cross-head speed was 500 mm/min. Samples were tested at 23° C.

### Example 1

This example illustrates that the addition of the high-styrene content styrene-butadiene copolymer additive to a rubber composition breaks the compromise between increased low-strain rigidity and its effects on processability and cohesion.

Rubber formulations were prepared with the component amounts shown in Table 1. The first witness formulation (W1) included no reinforcing resin, no additional carbon black nor any of the high-styrene content styrene-butadiene copolymer additive. The other witness formulations included increasing the carbon black levels (W2, W3) over the level in W1 and adding a formaldehyde-phenolic resin (W4, W5) to the base witness formulation (W1) as another means of increasing its rigidity. The hexamethylenetetramine was added with the resin as a cross-linking methylene donor as known in the art of reinforcing resins.

TABLE 1

| Formulations | W1 | W2 | W3 | W4 | W5 | F1 | F2 | F3 |
|---|---|---|---|---|---|---|---|---|
| Components | | | | | | | | |
| NR | 50 | 50 | 50 | 50 | 50 | 50 | 50 | 50 |
| SBR | 50 | 50 | 50 | 50 | 50 | 50 | 50 | 50 |
| N326 | 50 | 50 | 50 | 50 | 50 | 50 | 50 | 50 |
| N326 | | 10 | 20 | | | | | |
| Formal-phenolic Resin | | | | 10 | 20 | | | |
| Hexamethylenetetramine | | | | 1.5 | 3 | | | |
| SBR additive, 63 wt. % Styrene | | | | | | 10 | 20 | 30 |
| Additives | 3 | 3 | 3 | 3 | 3 | 3 | 3 | 3 |
| Vulcanization Pkg. | 7 | 7 | 7 | 7 | 7 | 7 | 7 | 7 |

Formulations F1-F3 were prepared with the same components as the base witness W1 but with the addition of the high-styrene content styrene-butadiene copolymer additive to increase the rigidity. The styrene-butadiene copolymer additive had a styrene content of 63 wt. %, and is available from Industrias Negromex S.A. de C.V. of Mexico under the trade name EMULPRENE 260.

The rubber components of all the formulations were a 50-50 mix of natural rubber and SBR. Carbon black N326 was added to each of the formulations as a reinforcing filler. The additives included antidegradants and the vulcanization package included sulfur, accelerator, stearic acid and zinc oxide.

To prepare each of the formulations, all the materials except for the sulfur and accelerators (and the hexamethylenetetramine if used) were added to a Banbury mixer and processed until well incorporated. The mixture was then dropped from the mixer, transferred to a mill and cooled.

The sulfur and accelerator (and the hexamethylenetetramine if used) were then added to the cooled mix and processed on the mill until fully incorporated. The product was then tested for its properties in accordance with the testing procedures described above. For the cured properties, the product was cured for 25 minutes at 150° C.

TABLE 2
Physical Properties

| | W1 | W2 | W3 | W4 | W5 | F1 | F2 | F3 |
|---|---|---|---|---|---|---|---|---|
| Uncured | | | | | | | | |
| Properties | | | | | | | | |
| Mooney ML | 64 | 73 | 86 | 72 | 76 | 61 | 59 | 59 |
| 1 + 4 | | | | | | | | |
| Scorch @ | 13 | 11 | 9 | 7 | 5 | 16 | 18 | 20 |
| 130° C., min | | | | | | | | |
| Cured | | | | | | | | |
| Properties | | | | | | | | |
| MA10, MPa | 5.5 | 6.3 | 7.5 | 10.4 | 16.8 | 6.7 | 8.3 | 10.0 |
| MA100, MPa | 2.2 | 2.5 | 3.1 | 2.5 | 3.3 | 2.2 | 2.4 | 2.6 |
| Elongation | 25 | 22 | 24 | 20 | 15 | 26 | 24 | 25 |
| Stress, MPa | | | | | | | | |
| Elongation at | 542 | 469 | 433 | 527 | 426 | 580 | 560 | 583 |
| Break, % | | | | | | | | |
| Tear Force | 63 | 68 | 71 | 51 | 38 | 74 | 73 | 54 |
| @ 23° C., | | | | | | | | |
| N/mm | | | | | | | | |
| Tear Strain | 228 | 217 | 192 | 210 | 129 | 270 | 256 | 220 |
| @ 23° C., % | | | | | | | | |

As may be seen from the results shown in Table 2, the increase in the level of carbon black in formulations W2 and W3 did increase the low-strain rigidity (MA10) but at a cost to the Mooney viscosity, scorch, elongation properties and tear properties. Likewise, the addition of the reinforcing resin in formulations W4 and W5 increased the low-strain rigidity (MA10) but at a cost to the Mooney viscosity, scorch, elongation properties and tear properties.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tire component, the tire component comprising a rubber composition that is based upon a cross-linkable elastomer composition, the cross-linkable elastomer composition comprising, per 100 parts by weight of rubber (phr):
100 phr an essentially unsaturated diene rubber;
between 30 phr and 150 phr of a reinforcing filler;
between 2 phr and 50 phr of a high-styrene content styrene-butadiene copolymer additive, the styrene-butadiene copolymer additive having a styrene content of between 50 wt. % and 90 wt. %; and
a vulcanization system.

2. The tire component of claim 1, wherein the styrene content is between 55 wt. % and 80 wt. %.

3. The tire component of claim 1, wherein the styrene content is between 60 wt. % and 75 wt. %.

4. The tire component of claim 3, wherein the high-styrene content styrene-butadiene copolymer additive is in an amount of between 10 phr and 30 phr.

5. The tire component of claim 4, wherein the essentially unsaturated diene elastomer is a highly unsaturated diene elastomer.

6. The tire component of claim 5, wherein the tire component is a bead area component.

7. The tire component of claim 1, wherein the high-styrene content styrene-butadiene copolymer additive is in an amount of between 5 phr and 40 phr.

8. The tire component of claim 1, wherein the high-styrene content styrene-butadiene copolymer additive is in an amount of between 10 phr and 30 phr.

9. The tire component of claim 1, wherein the reinforcing filler is carbon black.

10. The tire component of claim 1, wherein the reinforcing filler is selected from carbon black, silica or combinations thereof.

11. The tire component of claim 1, wherein the essentially unsaturated diene elastomer is a highly unsaturated diene elastomer.

12. The tire component of claim 11, wherein the highly unsaturated diene elastomer is selected from a polybutadiene, a synthetic polyisoprene, a natural rubber, a butadiene-styrene copolymer or combinations thereof.

13. The tire component of claim 1, wherein the tire component is a bead area component.

14. The tire component of claim 1, wherein the tire component is a tread.

15. A method for manufacturing a tire component, the method comprising:
mixing together components of a rubber composition into a non-productive mix, the components comprising 100 phr of a highly unsaturated diene elastomer, between 30 phr and 150 phr of a reinforcing filler and between 2 phr and 50 phr of a high-styrene content styrene-butadiene copolymer additive, the styrene-butadiene copolymer additive having a styrene content of between 50 wt. % and 90 wt. %;
cooling the non-productive mix;
mixing a vulcanization system into the non-productive mix to convert the non-productive mix to a productive mix;
forming the tire component from the productive mix.

16. The method of claim 15, wherein the styrene content is between 55 wt. % and 80 wt. %.

17. The method of claim 7, wherein the tire component is a bead area component.
